(19) United States
(12) Patent Application Publication
(10) Pub. No.: US 2022/0114767 A1
(43) Pub. Date: Apr. 14, 2022

(54) DEEP EXAMPLE-BASED FACIAL MAKEUP TRANSFER SYSTEM

(71) Applicant: MIRRORI CO LTD., Haifa (IL)

(72) Inventors: Matan SELA, Haifa (IL); Itai CASPI, Haifa (IL); Mira AWWAD-KHREISH, Haifa (IL)

(21) Appl. No.: 17/066,095

(22) Filed: Oct. 8, 2020

(51) Int. Cl. G06T 11/00; G06K 9/00; G06K 9/62; G06T 3/40; G06T 9/00

(52) U.S. Cl. CPC G06T 11/00; G06K 9/00228; G06T 9/00; G06T 3/40; G06K 9/6215

(57) ABSTRACT

A method comprising: receiving a reference facial image of a first subject, wherein the reference image represents a specified makeup style applied to a face of the first subject; receiving a target facial image of a target subject without makeup; performing pixel-wise alignment of the reference image to the target image; generating a translation of the reference image to obtain a de-makeup version of the reference image representing the face of the first subject without the specified makeup style; calculating an appearance modification contribution representing a difference between the reference image and the de-makeup version; and adding the calculated appearance modification contribution to the target image, to construct a modified the target image which represents the specified makeup style applied to a face of the target subject.

### FIELD OF THE INVENTION

The invention relates to the field of computer image processing.

### BACKGROUND OF THE INVENTION

Makeup is used to improve one's facial appearance with special cosmetics, such as foundation for concealing facial flaws, eyeliner, eye shadow and lipstick. However, with thousands of available techniques and products, and variations in face types and personal preferences, selecting a desired facial style typically requires professional assistance. In addition, the procedure of makeup application onto one's face is costly and time-consuming when performed by a professional.

One promising avenue for streamlining the makeup process and making it more efficient, are virtual makeup try-on systems, which allow a consumer to view how specific makeup styles are expected to look once applied to the consumer, without having to actually apply the makeup products.

It would be advantageous to allow the consumer to select whole facial makeup styles from images of models wearing various styles, and have the selected style accurately virtually simulated on the face of the consumer.

The foregoing examples of the related art and limitations related therewith are intended to be illustrative and not exclusive. Other limitations of the related art will become apparent to those of skill in the art upon a reading of the specification and a study of the figures.

### SUMMARY OF THE INVENTION

The following embodiments and aspects thereof are described and illustrated in conjunction with systems, tools and methods which are meant to be exemplary and illustrative, not limiting in scope.

There is provided, in an embodiment, a system comprising: at least one hardware processor; and a non-transitory computer-readable storage medium having stored thereon program instructions, the program instructions executable by the at least one hardware processor to: receive a reference facial image of a first subject, wherein the reference image represents a specified makeup style applied to a face of the first subject, receive a target facial image of a target subject without makeup, perform pixel-wise alignment of the reference image to the target image, generate a translation of the reference image to obtain a de-makeup version of the reference image representing the face of the first subject without the specified makeup style, calculate an appearance modification contribution representing a difference between the reference image and the de-makeup version, and add the calculated appearance modification contribution to the target image, to construct a modified the target image which represents the specified makeup style applied to a face of the target subject.

There is also provided, in an embodiment, a method comprising: receiving a reference facial image of a first subject, wherein the reference image represents a specified makeup style applied to a face of the first subject; receiving a target facial image of a target subject without makeup; performing pixel-wise alignment of the reference image to the target image; generating a translation of the reference image to obtain a de-makeup version of the reference image representing the face of the first subject without the specified makeup style; calculating an appearance modification contribution representing a difference between the reference image and the de-makeup version; and adding the calculated appearance modification contribution to the target image, to construct a modified the target image which represents the specified makeup style applied to a face of the target subject.

There is further provided, in an embodiment, a computer program product comprising a non-transitory computer-readable storage medium having program instructions embodied therewith, the program instructions executable by at least one hardware processor to: receive a reference facial image of a first subject, wherein the reference image represents a specified makeup style applied to a face of the first subject; receive a target facial image of a target subject without makeup; perform pixel-wise alignment of the reference image to the target image; generate a translation of the reference image to obtain a de-makeup version of the reference image representing the face of the first subject without the specified makeup style; calculate an appearance modification contribution representing a difference between the reference image and the de-makeup version; and add the calculated appearance modification contribution to the target image, to construct a modified the target image which represents the specified makeup style applied to a face of the target subject.

In some embodiments, the pixel-wise alignment is a dense alignment which creates a pixel-to-pixel correspondence between the reference image and the target image.

In some embodiments, the pixel-wise alignment is based, at least in part, on detecting a plurality of corresponding facial features in the reference and target images

In some embodiments, the generating of the translation comprises translating the reference image from a source domain representing facial images with makeup, to a target domain representing facial images without makeup, based, at least in part, on learning a mapping between the source and target domains.

In some embodiments, the performing comprises performing normalizing of the reference image based, at least in part, on illumination conditions of represented in the target image.

In some embodiments, the generating, calculating, and adding comprise creating embeddings of each of the reference image, de-makeup version, and target image, from an image space to into a high-dimension linear feature space, wherein the generating, calculating, and adding are performed using the embeddings.

In some embodiments, the embedding is performed using a trained convolutional neural network.

In some embodiments, the constructing further comprises decoding the modified target image, to convert it back to the image space.

In some embodiments, the decoding is based on an iterative optimization process comprising image upscaling from an initial resolution to reach a desired final resolution.

In addition to the exemplary aspects and embodiments described above, further aspects and embodiments will become apparent by reference to the figures and by study of the following detailed description.

### BRIEF DESCRIPTION OF THE DRAWINGS

Exemplary embodiments are illustrated in referenced figures. Dimensions of components and features shown in the figures are generally chosen for convenience and clarity of presentation and are not necessarily shown to scale. The figures are listed below.

FIG. 1 shows an exemplary system for automatically adding a specified makeup style to a target face image, based on a reference image as a style example, according to exemplary embodiments of the present invention;

FIG. 2 is a flowchart detailing the functional steps in a process for automatically adding a specified makeup style to a target face image, based on a reference image as a style example, according to exemplary embodiments of the present invention;

FIG. 3 is a schematic diagram of a process for automatically adding a specified makeup style to a target face image, based on a reference image as a style example, according to exemplary embodiments of the present invention;

FIG. 4 is a high level illustration of the functional steps in a process for automatically adding a specified makeup style to a target face image, based on a reference image as a style example, according to exemplary embodiments of the present invention;

FIG. 5 schematically illustrates a lighting normalization process, according to exemplary embodiments of the present invention;

FIG. 6 schematically illustrates an embedding process into a linear feature space, according to exemplary embodiments of the present invention; and

FIG. 7 schematically illustrates an image recovery and optimization process, according to exemplary embodiments of the present invention.

### DETAILED DESCRIPTION OF THE INVENTION

Described herein are a system, method, and computer program product for automatically adding a specified makeup style to a target face image, based on a reference image depicting a model wearing the specified style.

In some embodiments, the present method calculates an appearance modification contribution, e.g., a makeup layer, associated with the makeup style in the reference image, and transfers the calculated appearance modification onto the target face image.

In some embodiments, the present method does not rely on paired pre- and post-makeup images of the reference style to calculate an appearance modification contribution.

In some embodiments, the invention disclosed herein produces photorealistic images representing a makeup layer transferred from a reference image, while preserving facial identities and scene properties of input images while transferring makeup from images.

Reliably and accurately transferring the appearance modification contribution of a makeup style from a reference image onto a target face image must meet three main criteria:
The resulting image must look realistic to the user;
the resulting image must preserve the identity of the individual; and
the resulting image must accurately reflect the makeup layer from the reference image, without the effect of environmental factors.

Some known methods for transferring a makeup layer from one facial image to another rely on calculating a color component in the reference image and transferring the color component to the target image. However, pixel color values in a reference image reflect a plurality of factors, including, but not limited to, lighting conditions at the scene of the image, subject skin tone, and reflections from the environment onto the subject. These method typically cannot decouple the color of the makeup from model skin tone and other environmental factors. In addition, this approach fails to transfer higher level textural changes which can be realized with real physical makeup.

Other solutions include model-based approaches and learning-based approaches. Model-based approaches try to estimate major factors impacting the image formation process, such as geometry, lighting, and color reflected from the captured facial surface. By manipulating these factors and transferring only color reflections into the target image, a modified version of the image can be produced for simulating the makeup effect. However, this approach suffers from non-realistic artifacts derived from the complex factorization process. Learning-based approaches try to train a model to map images from the domain of images of subjects without makeup to the domain of images of subjects with makeup. This mapping function is often conditioned on the image with the desired style, and thus this approach often fails to generalize and transfer makeup styles unobserved in the training phase.

Accordingly, in some embodiments, the present disclosure provides for transferring a makeup style layer, also termed herein “appearance modification contribution,” from a reference image to a target image. In some embodiments, the reference facial image is, e.g., an image of a makeup artist or model wearing a specified makeup style.

In some embodiments, the makeup transfer method of the present disclosure provides for generating an image predicting the expected appearance of a user, after application of a makeup layer reflected in a reference image.

In some embodiments, at a first step, a dense pixel-level alignment between a reference image of a model wearing a specified makeup style, and a target image of a user onto which the specified style is to be simulated, may be computed.

In some embodiment, the aligned reference image may then be normalized so as to contain the lighting conditions from the target image. In some embodiments, one or more image preprocessing steps may be performed with respect to the user image, e.g., adding a virtual foundation makeup layer to fill in skin pores, removal of spots and blemishes, removal of dark circles around the eyes, etc.

Then, the present method provides for makeup removal from the reference image, e.g., by mapping the reference image to the domain of images without makeup.

In some embodiments, next, the target image along with the normalized reference images (with and without the makeup layer) are embedded into a linear feature space. In some embodiments, a trained convolutional neural network may be employed to compute feature maps of the images, wherein the computed feature map is sensitive to different textural element in the image. In some embodiments, the linear feature space may allow performing a plurality of linear operation on the feature maps, to determine n output image whose feature map is the closest to reference image. In some embodiments, this is performed using a multi-scale optimization method.

In some embodiments, a representation of an output image of the user wearing the specified makeup style may be calculated by adding the difference between the embedding of the reference images with and without the makeup layer, to the user image. Finally, the embedding is decoded into an image, by computing the inverse map of the output representation.

A potential advantage of the present disclosure is, therefore, in that it provides for a faithful and photorealistic transfer of makeup style between a single reference image and a target image, without the need for generating pre- and post-makeup reference images for each style. The present method can perform such style transfer with respect to a diverse range of styles, while preserving the identity of the user.

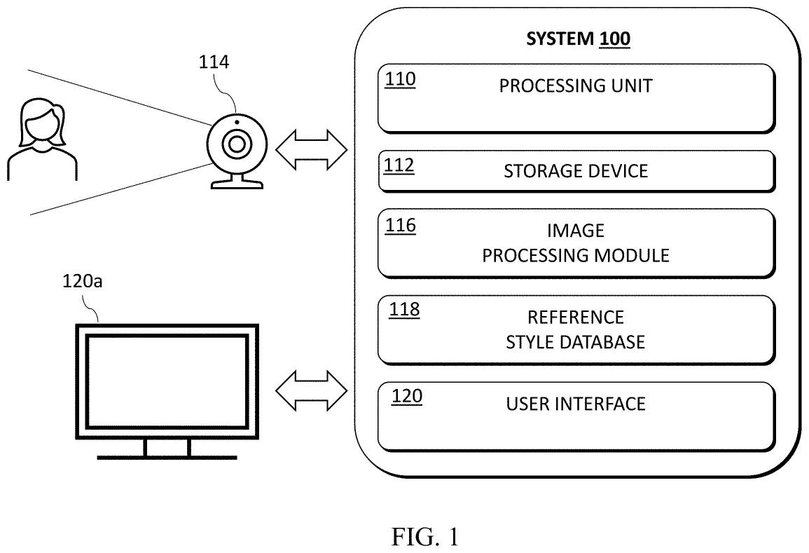

FIG. 1 illustrates an exemplary system 100 for automatically adding a specified makeup style to a target face image, based on a reference image as a style example, in accordance with some embodiments of the present invention.

System 100 as described herein is only an exemplary embodiment of the present invention, and in practice may have more or fewer components than shown, may combine two or more of the components, or may have a different configuration or arrangement of the components. The various components of system 100 may be implemented in hardware, software, or a combination of both hardware and software. In various embodiments, system 100 may comprise a dedicated hardware device, or may form an addition to or extension of an existing device. In some embodiments, components of system 100 may be implemented in the cloud, any desktop computing device, and/or any mobile computing device.

In some embodiments, system 100 may comprise a processing unit 110 and memory storage device 112. In some embodiments, system 100 may store in a non-volatile memory thereof, such as storage device 112, software instructions or components configured to operate a processing unit (also “hardware processor,” “CPU,” or simply “processor”), such as processing unit 110. In some embodiments, the software components may include an operating system, including various software components and/or drivers for controlling and managing general system tasks (e.g., memory management, storage device control, power management, etc.) and facilitating communication between various hardware and software components.

System 100 may include an imaging device, e.g., imaging device 114 which may be a digital camera provided to capture one or more facial images of users of system 100, and transfer the captured images to image processing module 116. Imaging device 114 is broadly defined as any device that captures images and represents them as data. In some embodiments, imaging device 114 may be configured to detect RGB (red-green-blue) color data. In other embodiments, imaging device 114 may be configured to detect at least one of monochrome, ultraviolet (UV), near infrared (NIR), and short-wave infrared (SWIR) spectral data. Imaging device 114 may further comprise, e.g., zoom, magnification, and/or focus capabilities. imaging device 114 may also comprise such functionalities as color filtering, polarization, and/or glare removal, for optimum visualization. In some embodiments, system 100 may further comprise a light source configured to illuminate a scene captured by imaging device 114

In some embodiments, the software instructions and/or components operating processing unit 110 may include instructions for receiving and analyzing the images captured by imaging device 114, e.g., using image processing module 116.

In some embodiments, a user interface 120 of system 100 comprises a display monitor 120a for displaying images and a control panel for controlling system 100. In some variations, display 120a may be used to display images captured by imaging device 114 and/or processed by image processing module 116.

In some embodiments, reference style database 118 is provided to store a plurality of reference facial images comprising a plurality of specified makeup styles.

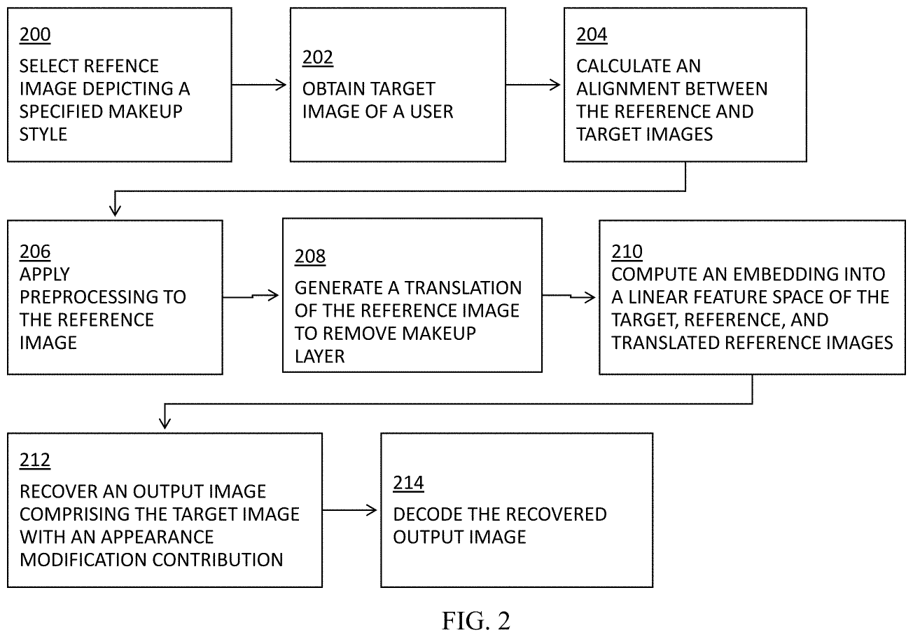

FIG. 2 is a flowchart detailing the functional steps in a process for automated real-time generating of lower-noise, high dynamic range, motion compensated images of a scene, using a high frame rate imaging device, in accordance with some embodiments of the present invention.

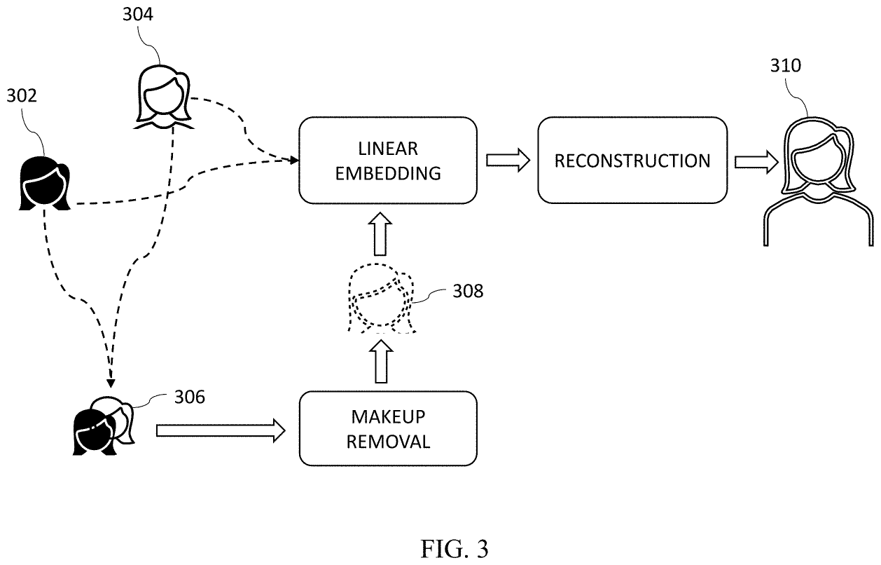

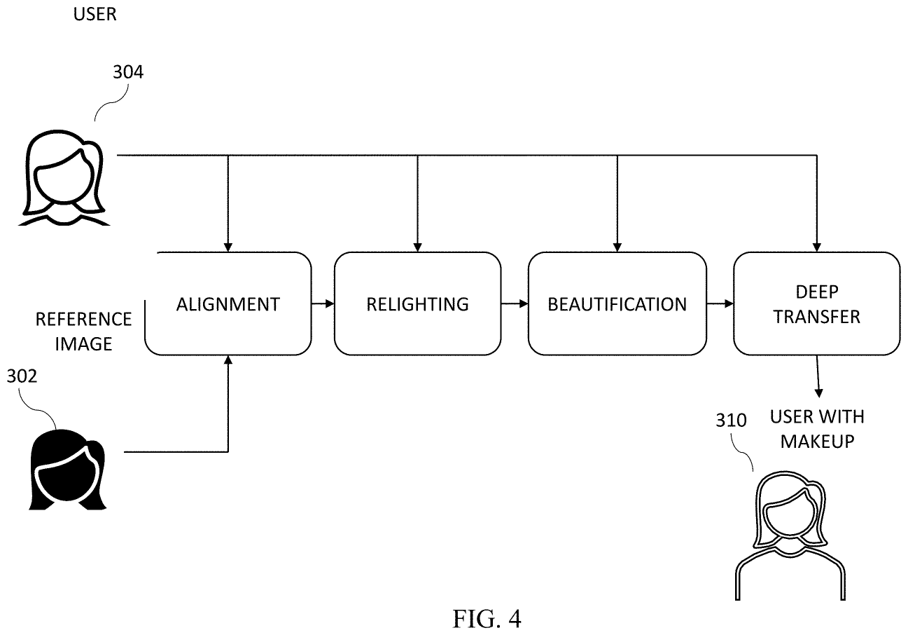

In some embodiments, at step 200, an operator of a system of the present disclosure, e.g., system 100 in FIG. 1, may access the reference style database 118 to select a reference image depicting a makeup model wearing a specified makeup style. For example, with reference to the schematic diagrams of the present process in FIGS. 3 and 4, reference image 302 may be selected.

In some embodiments, at step 202, an operator of system 100 may operate imaging device 114 to capture a target facial image of a user, e.g., target image 304 in FIGS. 3 and 4, wherein the target image depicts the user wearing no makeup.

In some embodiments, at step 204, image processing module 116 may calculate an alignment between the reference image 302 and the target image 304, to generate an aligned image 306 in FIG. 3. In some embodiments, image alignment comprises aligning facial components and features, e.g., eye, nose, mouth, and contours. In some embodiments, alignment between the reference image 302 and the target image 304 may not be based on detecting facial features. In some embodiments, the alignment may be based on any suitable known alignment method. In some embodiments, the alignment is a dense alignment.

In some embodiments, alignment means warping a first image having a first plurality of landmarks such that a resulting aligned image has a pixel-to-pixel correspondence to a second image having a similar plurality of landmarks. In other words, each pixel in the resulting aligned image has a corresponding pixel at an identical pixel location in the second image. For example, in some embodiments, the position of the reference and target faces may be determined by enclosing each face within a bounding box that provides the spatial coordinates of each face. Then, the present method may generate landmarks around different facial features and components in both images. By creating a correspondence between the coordinates of each facial feature in both images, the face in the reference image may be geometrically aligned or warped, such that its geometry fits that of the target face in the target image. Accordingly, in some embodiments, the alignment of step 204 results in a mapping any face-region pixel in the target image to a corresponding pixel having the same anatomical position in the human face, in the reference image.

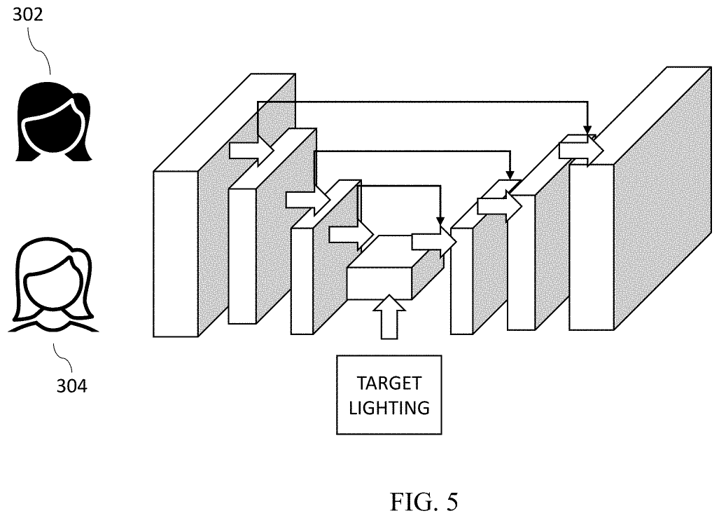

In some embodiments, at step 206, a preprocessing stage may be performed with respect to the aligned images resulting from step 204. For example, in some embodiments, preprocessing may comprise normalization of the reference image to correct for illumination variations between the reference and target images. As can be seen in FIG. 5, in some embodiments, step 206 normalizes the reference image 302 based on illumination conditions of the target image 304, to generate a normalized reference image 302a.

In some embodiments, one or more image preprocessing steps may be performed with respect to the user image, e.g., by smoothing of the skin, adding a virtual foundation makeup layer, filling in of skin pores, and removal of nevi, moles, spots and blemishes.

In some embodiments, any suitable preprocessing and/or normalization algorithm may be employed which operate to the dynamic range of the image, e.g., gain/offset correction to stretch the image dynamic range so that it fits the dynamic range of a given interval; histogram equalization to transform the distribution of pixels in the image in order to obtain a uniform-distributed histogram; non-linear transforms which applies a non-linear function, such as logarithm or power functions, on the image to obtain dynamic range compression; and/or homomorphic filtering, which processes the image in the frequency domain.

In some embodiments, at step 208, the aligned and normalized reference image 306, depicting a model wearing a specified makeup style, may be translated to depict a de-makeup image (308 in FIG. 3) of the model wearing no makeup by, e.g., removing a makeup layer in the reference image. In some embodiments, step 208 may comprise translating the reference image from a source domain ‘makeup’ X to a target domain ‘no makeup’ Y. In some embodiments, the translation is based, at least in part, on learning a mapping G: X→Y such that the distribution of images from G(X) is indistinguishable from the distribution Y. In some embodiments, this task may be accomplished in the absence of training data, using a method such as disclosed in, e.g., Jun-Yan Zhu et al. “Unpaired Image-to-Image Translation using Cycle-Consistent Adversarial Networks”, in IEEE International Conference on Computer Vision (ICCV), 2017.

Accordingly, in some embodiments, a translation algorithm as may be used by the present disclosure may be able to learn to translate between domains (e.g., ‘makeup’→‘no makeup’) without paired input-output examples, e.g., pairs of images showing a model with and without makeup. In some embodiments, such an algorithm learns an underlying relationship between the domains, e.g., they may be two different renderings of the same underlying facial features. In some embodiments, the learning process may exploit supervision at the domain level, based on given sets of images in domain X (‘makeup’) and domain Y (‘non makeup’).

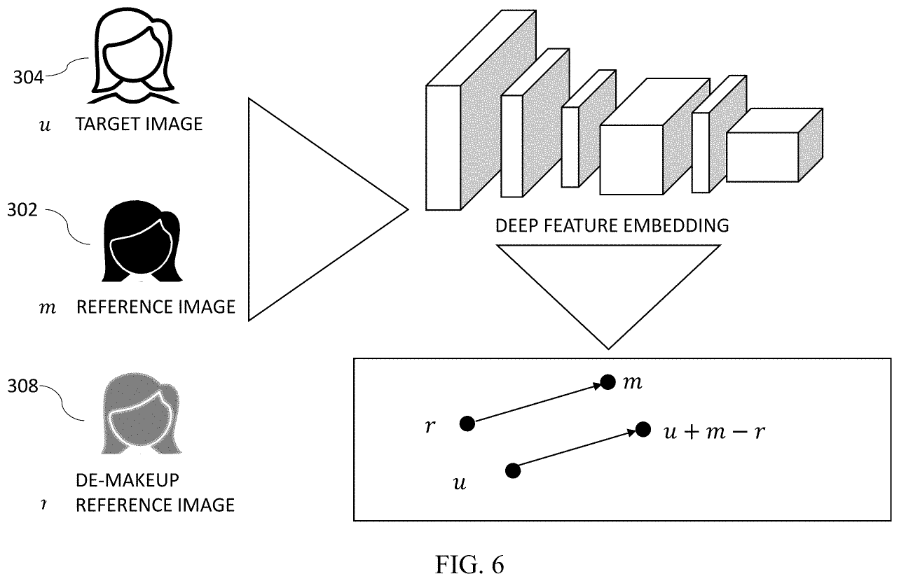

With reference to FIG. 6, in some embodiments, at step 210, the target image 304, the aligned image 306, and the de-makeup image 308 may be embedded into a higher-dimension linear feature space. In some embodiments, embedding the images into a higher-dimension linear feature space may allow to learn high-level similarity between images perceptually, i.e., to assess a perceptual distance which measures how similar are two images in a way that coincides with human judgment.

In some embodiments, further processing and/or modification of the target image 304 may be performed in the high dimensional linear representation space to, e.g., modify pixels of facial regions associated with properties considered unattractive. For example, this process may be used to eliminate dark circles and/or areas under the eye, by replacing pixel values in these regions with corresponding pixel values taken from the aligned image 306 and/or the de-makeup image 308.

In some embodiments, the embedding into a linear feature space may be performed using a trained convolutional neural network, wherein the network may be trained on a high-level image classification task. In some embodiments, internal activations of networks trained for high-level classification tasks may correspond to human perceptual judgments. In some embodiments, the embedding may be performed using, e.g., a supervised network (i.e., trained using annotated data), an unsupervised network, and/or a self-supervised network.

In some embodiments, at step 212, an appearance modification contribution may be computed between aligned reference image 306 and de-makeup image 308, and transferred to target image 304.

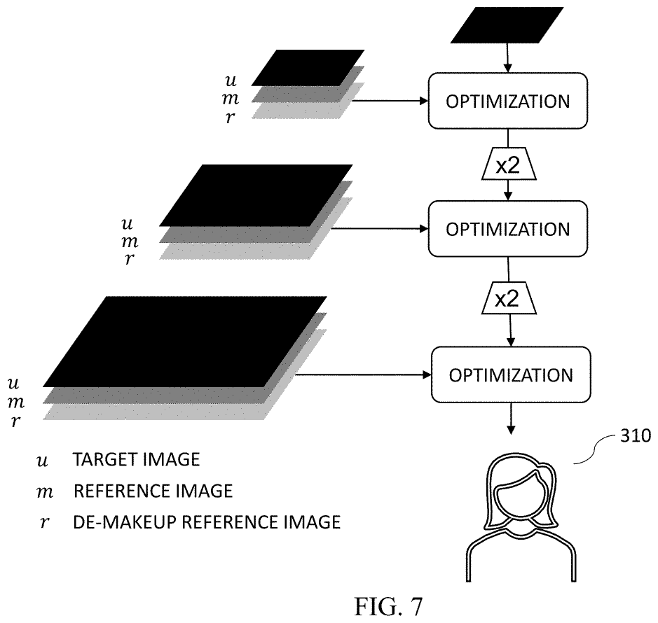

With reference to FIG. 7, in some embodiments, given a representation of target image 304 (denoted as u), reference image 302 (denoted as m), and de-makeup reference image 308 (denoted as r), an optimization procedure may be performed to recover an image with a representation of u+m−r.

In some embodiments, this operation may be performed with respect to all or only a portion of the pixels in the target image 304. In some embodiments, at least a portion of the pixels in the target image 304 may be overwritten with the values in the reference image 302. For example, the natural lip color of each person is different. Therefore, in pixel representations corresponding to the lip regions, the histogram of the values in target image 304 may be equalized to the histogram of values in m in the same region. This may help to ensure removal of non-realistic artifacts from the eventual reconstructed output image, such that the output image retain a phot-realistic quality.

In some embodiments, the optimization may start at a low resolution (e.g., 64×64), and may be initialized with the target image 302, to preserve the identity of the user. In some embodiments, the optimization may iterate for a specified number if iterations and upscale the result, wherein the upscaled version is used as an initialization for the next scale optimization, e.g., for the size of 128×128. This process may continue to iterate until a desired resolution is reached.

In some embodiments, the optimization function may be represented as:

$${min}_{x} {‖ φ ( x ) - z ‖}_{1} + η \cdot R ( x )$$

$$z = φ ( u ) + φ ( m ) - φ ( r )$$

$$R ( x ) = {\sum }_{i , j} {‖ {( ∇ x )}_{i , j} ‖}_{2}$$

In some embodiments, at step 214, the image representation of u+m−r may then be decoded and converted back to an image space, to generate an output image 310 predicting the expected appearance of the user after application of a makeup style reflected in reference image 302.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire. Rather, the computer readable storage medium is a non-transient (i.e., not-volatile) medium.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A system comprising:
at least one hardware processor; and
a non-transitory computer-readable storage medium having stored thereon program instructions, the program instructions executable by the at least one hardware processor to:
receive a reference facial image of a first subject, wherein said reference image represents a specified makeup style applied to a face of said first subject,
receive a target facial image of a target subject without makeup,
perform pixel-wise alignment of said reference image to said target image by normalizing the reference image to correct for illumination variations between the reference and target images,
generate a translation of said reference image to obtain a de-makeup version of said reference image representing said face of said first subject without said specified makeup style,
calculate an appearance modification contribution representing a difference between said reference image and said de-makeup version, and
add said calculated appearance modification contribution to said target image, to construct a modified said target image which represents said specified makeup style applied to a face of said target subject.

2. The system of claim 1, wherein said pixel-wise alignment is a dense alignment which creates a pixel-to-pixel correspondence between said reference image and said target image.

3. The system of claim 1, wherein said pixel-wise alignment is based, at least in part, on detecting a plurality of corresponding facial features in said reference and target images.

4. The system of claim 1, wherein said generating of said translation comprises translating said reference image from a source domain representing facial images with makeup, to a target domain representing facial images without makeup, based, at least in part, on learning a mapping between said source and target domains.

5. (canceled)

6. The system of claim 1, wherein said generating, calculating, and adding comprise creating embeddings of each of said reference image, de-makeup version, and target image, from an image space to a high-dimension linear feature space, wherein said generating, calculating, and adding are performed using said embeddings.

7. The system of claim 6, wherein said embedding is performed using a trained convolutional neural network.

8. The system of claim 6, wherein said constructing further comprises decoding said modified target image, to convert it back to said image space.

9. The system of claim 8, wherein said decoding is based on an iterative optimization process comprising image upscaling from an initial resolution to reach a desired final resolution.

10. A method comprising:
receiving a reference facial image of a first subject, wherein said reference image represents a specified makeup style applied to a face of said first subject;
receiving a target facial image of a target subject without makeup;
performing pixel-wise alignment of said reference image to said target image by normalizing the reference image to correct for illumination variations between the reference and target images;
generating a translation of said reference image to obtain a de-makeup version of said reference image representing said face of said first subject without said specified makeup style;
calculating an appearance modification contribution representing a difference between said reference image and said de-makeup version; and
adding said calculated appearance modification contribution to said target image, to construct a modified said target image which represents said specified makeup style applied to a face of said target subject.

11. The method of claim 10, wherein said pixel-wise alignment is a dense alignment which creates a pixel-to-pixel correspondence between said reference image and said target image.

12. The method of claim 10, wherein said pixel-wise alignment is based, at least in part, on detecting a plurality of corresponding facial features in said reference and target images.

13. The method of claim 10, wherein said generating of said translation comprises translating said reference image from a source domain representing facial images with makeup, to a target domain representing facial images without makeup, based, at least in part, on learning a mapping between said source and target domains.

14. (canceled)

15. The method of claim 10, wherein said generating, calculating, and adding comprise creating embeddings of each of said reference image, de-makeup version, and target image, from an image space to a high-dimension linear feature space, wherein said generating, calculating, and adding are performed using said embeddings.

16. The method of claim 15, wherein said embedding is performed using a trained convolutional neural network.

17. The method of claim 15, wherein said constructing further comprises decoding said modified target image, to convert it back to said image space.

18. The method of claim 17, wherein said decoding is based on an iterative optimization process comprising image upscaling from an initial resolution to reach a desired final resolution.

19. A computer program product comprising a non-transitory computer-readable storage medium having program instructions embodied therewith, the program instructions executable by at least one hardware processor to:
receive a reference facial image of a first subject, wherein said reference image represents a specified makeup style applied to a face of said first subject;
receive a target facial image of a target subject without makeup;
perform pixel-wise alignment of said reference image to said target image by normalizing the reference image to correct for illumination variations between the reference and target images;
generate a translation of said reference image to obtain a de-makeup version of said reference image representing said face of said first subject without said specified makeup style;
calculate an appearance modification contribution representing a difference between said reference image and said de-makeup version; and
add said calculated appearance modification contribution to said target image, to construct a modified said target image which represents said specified makeup style applied to a face of said target subject.

20. The computer program product of claim 19, wherein said generating, calculating, and adding comprise creating embeddings of each of said reference image, de-makeup version, and target image, from an image space to a high-dimension linear feature space, wherein said generating, calculating, and adding are performed using said embeddings.
